(19) United States
(12) Patent Application Publication
(10) Pub. No.: US 2018/0211189 A1
(43) Pub. Date: Jul. 26, 2018

(54) RECORD AGGREGATION DATABASE

(71) Applicant: Amadeus S.A.S., Biot (FR)

(72) Inventors: Selim Bessassi, Nice (FR); Caroline Dessenis, Antibes (FR); Marc Pelissier, Roquefort-les-pins (FR); Delphine Caron, Antibes (FR); Loic Fontolliet, Boston, MA (US)

(21) Appl. No.: 15/412,127

(22) Filed: Jan. 23, 2017

(51) Int. Cl. G06Q 10/02; G06F 17/30

(52) U.S. Cl. CPC G06Q 10/025; G06F 17/30864

(57) ABSTRACT

Systems, methods, and computer program products for aggregating data from related database records. A booking folder database stores a plurality of booking folder records. Each booking folder record links reservation records and other data relating to a particular trip or group of trips by storing identifiers identifying the reservation records to be linked. To view or modify a trip, a client application may search the database for a booking folder record matching a search term. Based on the identifiers in the matching booking folder record, the client application may retrieve the linked reservation records, and aggregate the reservation records into a single booking folder view of the entire trip. To modify the itinerary of the trip, the client application may add or remove links from the booking folder record, or modify the linked reservation records.

### BACKGROUND

The invention generally relates to computers and computer systems and, in particular, to methods, systems, and computer program products for aggregating data from related database records.

In the information age, it has become common for information on persons, transactions, and other subjects to be collected and stored in databases. Much of the data collected by separate databases is often redundant or related in some way. For example, a single person or process may generate data during separate data processing sessions that are related to a single task or project, but that occur at different times and/or are processed by different systems. These separate data processing sessions may result in database records that relate to a single event or transaction being stored in separate databases or in unassociated records within partitions of a single database.

For example, in the travel industry, travel agents may book travel products for customers with reservation systems operated by different travel providers. For example, a single trip may include reservations for air travel, hotels, car rentals, and other travel related products. When a travel product is reserved, one or more electronic records documenting the reserved travel product are typically stored in a database at a global distribution system. The database may comprise a collection of records that contain information about travelers and their itineraries with regard to travel products reserved from that particular travel provider. Each database record may also define a contract between the travel agent and the travel provider for products reserved by the database record.

Reserving products from multiple travel providers may result in the generation of unassociated database records that are not linked with each other. When reservations for a particular traveler or itinerary are unassociated, it may become difficult for a travel agent to determine the scope of the traveler's entire itinerary. Moreover, it may be difficult for the travel agent to identify each contract they have with a particular passenger.

Travel providers may face a different problem resulting from the generation of multiple unassociated database records. Each database record may define a contract between the travel provider and a particular travel agency. However, a single traveler may have used more than one travel agency to book their trip, resulting in separate database records for products provided to the same passenger by the same travel provider for a single trip. In the case of air travel, for example, the resulting division of the traveler's itinerary between multiple contracts may prevent the airline from applying policies regarding pricing for the full itinerary.

Thus, improved systems, methods, and computer program products for aggregating data from related database records are needed that provide users and systems with a single view of the database records.

### SUMMARY

In an embodiment of the invention, a data processing system includes one or more processors and a memory coupled to the processors. The memory stores data comprising a booking folder database and program code. When executed by at least one of the one or more processors, the program code may cause the system to receive a first request to view a booking folder. The first request may include a search term, and in response to receiving the first request, the system may retrieve a booking folder record that matches the search term from the booking folder database. The booking folder record may define a first identifier that identifies a first reservation record. The system may use the first identifier from the booking folder record to retrieve the first reservation record and transmit the booking folder to a user system. The booking folder may include first data from the first reservation record.

In another aspect of the invention, the program code may cause the system to create the booking folder record in the booking folder database, and associate the booking folder record with a reservation record. Alternatively, after a booking folder is created, the booking folder record and the reservation record may be disassociated by removing the identifier for the reservation record from the booking folder.

In another aspect of the invention, the booking folder record may further define a second identifier that identifies a second reservation record, and the program code may further cause the system to use the second identifier from the booking folder record to retrieve the second reservation record, and add second data from the second reservation record to the booking folder.

In another aspect of the invention, the program code may cause the system to retrieve the booking folder record by attaching, by a context coordinator, a context header to a query, transmitting the query from the context coordinator to the booking folder database, retrieving the booking folder from the booking folder database, storing the booking folder in the context header, attaching the context header to a reply, transmitting the reply from the booking folder database to the context coordinator, and detaching, by the context coordinator, the context header from the reply.

In another aspect of the invention, the program code may cause the system to create the booking folder record in the booking folder database by receiving, prior to the first request, a second request that includes the search term and the first identifier. In response to receiving the second request, the program code may cause the system to store the search term in a first field of the booking folder record, store the first identifier in a second field of the booking folder record, generate a folder identifier, and store the folder identifier in a third field of the booking folder record. The program code may then cause the system to store the booking folder record in the booking folder database.

In another aspect of the invention, the booking folder may be transmitted to the user system via an application programming interface, and the data processing system may further comprise a client computer running a client application that interfaces with the application programming interface and provides a user interface for displaying the booking folder and a server computer running a database management application that manages the booking folder database.

In another aspect of the invention, the booking folder record may aggregate a plurality of reservation records without replicating data found in any of the reservation records.

In another aspect of the invention, the program code may further cause the system to, in response to receiving the second request to update an itinerary, retrieve the booking folder record, use the first identifier from the booking folder record to retrieve the first reservation record, and update the itinerary by modifying the first reservation record.

In another aspect of the invention, the program code may further cause the system to, in response to receiving the second request to update the itinerary, retrieve the booking folder record, and update the itinerary by storing the second identifier in the booking folder record, the second identifier identifying a second reservation record that defines a travel product that is being added to the itinerary.

In another embodiment of the invention, a method may include receiving, at the data processing system, the first request to view the booking folder. The first request may include the search term, and in response to receiving the request, the method may retrieve the booking folder record that matches the search term from the booking folder database. The booking folder record may define the first identifier that identifies the first reservation record, and the method may use the first identifier from the booking folder record to retrieve the first reservation record. The method may further include transmitting the booking folder to the user system, and the booking folder may include first data from the first reservation record.

In another aspect of the invention, the method may further include creating the booking folder record in the booking folder database, and associating the booking folder record with the reservation record. Alternatively, after a booking folder is created, the method may further included disassociating the booking folder record and the reservation record by removing the identifier for the reservation record from the booking folder.

In another aspect of the invention, the booking folder record may further define the second identifier that identifies the second reservation record, and the method may further include using the second identifier from the booking folder record to retrieve the second reservation record, and adding the second data from the second reservation record to the booking folder.

In another aspect of the invention, the method may retrieve the booking folder by, attaching, by the context coordinator, the context header to the query, transmitting the query from the context coordinator to the booking folder database, retrieving the booking folder from the booking folder database, storing the booking folder in the context header, attaching the context header to the reply, transmitting the reply from the booking folder database to the context coordinator, and detaching, by the context coordinator, the context header from the reply.

In another aspect of the invention, the method may create the booking folder record in the booking folder database by receiving, prior to the first request, the second request that includes the search term and the first identifier. In response to receiving the second request, the method may store the search term in the first field of the booking folder record, store the first identifier in the second field of the booking folder record, generate the folder identifier, and store the folder identifier in the third field of the booking folder record. The method may then store the booking folder record in the booking folder database.

In another aspect of the invention, the method may further include storing transversal data in a fourth field of the booking folder record.

In another aspect of the invention, the booking folder may be transmitted to the user system over the application programming interface, and the data processing system may include the client application that interfaces with the application interface and provides the user interface for displaying the booking folder and the database management application that manages the booking folder database.

In another aspect of the invention, the plurality of reservation records may be aggregated by the booking folder record without replicating data found in any of the reservation records.

In another aspect of the invention, the method may further include, in response to receiving the second request to update the itinerary, retrieving the booking folder record, using the first identifier from the booking folder record to retrieve the first reservation record, and updating the itinerary by modifying the first reservation record.

In another aspect of the invention, the method may further include, in response to receiving the second request to update the itinerary, retrieving the booking folder record, and updating the itinerary by storing the second identifier in the booking folder record, the second identifier identifying the second reservation record that defines the travel product that is being added to the itinerary.

In another embodiment of the invention, a computer program product includes a non-transitory computer-readable storage medium including program code. The program code may be configured, when executed by the one or more processors, to cause the one or more processors to receive the first request to view the booking folder. The first request may include the search term, and in response to receiving the first request, the code may cause the processors to retrieve the booking folder record that matches the search term from the booking folder database. The booking folder record may define the first identifier that identifies the first reservation record. The code may cause the processors to use the first identifier from the booking folder record to retrieve the first reservation record, and transmit the booking folder to a user system. The booking folder may include the first data from the first reservation record.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a travel agency system, a Global Distribution System (GDS), and an aggregation database.

FIG. 2 is a diagrammatic view of an exemplary computer that may be used to provide the operating environment of FIG. 1.

FIG. 3 is a diagrammatic view of the GDS of FIG. 1 including a services integrator and an Open Back End (OBE) layer.

FIG. 4 is a diagrammatic view of the GDS of FIG. 3 depicting a context coordinator application, a folder services application, a record storage application, a record access application, and the aggregation database hosted in the OBE layer.

FIG. 5 is a sequence diagram depicting message flow between the applications and the aggregation database of FIG. 4 for creating a booking folder record.

FIG. 6 is a sequence diagram depicting message flow between the applications and the aggregation database of FIG. 4 for retrieving a booking folder record.

FIG. 7 is a diagrammatic view of a booking folder that may be displayed by the travel agency system of FIG. 1 in an embodiment of the invention.

FIG. 8 is a diagrammatic view of a booking folder that may be displayed by the travel agency system of FIG. 1 in another embodiment of the invention.

FIG. 9 is a diagrammatic view of a booking folder that may be displayed by the travel agency system of FIG. 1 in yet another embodiment of the invention.

FIG. 10 is a flow chart of a process that may be executed by the GDS and/or travel agency system of FIG. 1 to create a booking folder record.

FIG. 11 is a flow chart of a process that may be executed by the GDS and/or travel agency system of FIG. 1 to add reservations to the booking folder record created in FIG. 10.

### DETAILED DESCRIPTION

Embodiments of the invention may be implemented by a data processing system that provides processing and database functions which enable and/or facilitate interconnections between one or more travel provider systems, travel agency systems, and/or database systems. The database systems may include a new type of database that stores and manages booking folder records. These booking folder records may provide a single working repository for trip management by the traveler, a travel agent, or other system user. The booking folder may thereby provide users of the data processing system with a single access point for viewing and managing all trip information for the traveler that maintains compatibility with existing reservation record standards.

A booking folder record may be created at the beginning of a trip planning session. As travel products are reserved for the trip, a record locator or other record identifier may be added to the booking folder record for each reservation made. The booking folder record may be stored in a centralized database so that external systems can access the booking folder record. In response to a request to view or modify the trip, the booking folder database may be queried for the booking folder record corresponding to the trip. The requesting system may then identify each reservation record associated with the booking folder record, and retrieve the identified records from their corresponding databases. The data provided by the booking folder and reservation records may be aggregated into a booking folder that provides a view of the entire trip. The booking folder database may thereby enable viewing of aggregated itineraries for a particular traveler, group of travelers, or some other stakeholder in the itinerary.

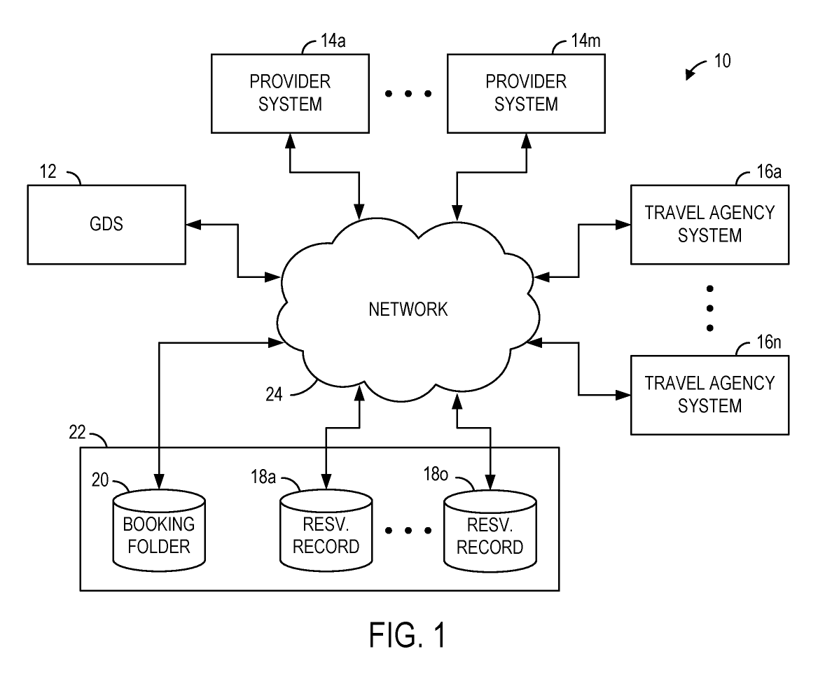

Referring now to FIG. 1, an operating environment 10 in accordance with an embodiment of the invention may include a GDS 12, one or more provider systems 14a-14m, one or more travel agency systems 16a-16n, one or more reservation databases 18a-18o, and a booking folder database 20. The reservation databases 18a-18o and a booking folder database 20 may be independent databases, or may be stored in an aggregation database 22. In an embodiment of the invention, each of the provider systems 14a-14m may host or be associated with one of the reservation databases 18a-18o, or may use a reservation database hosted by another system, such as the GDS 12. Each of the GDS 12, provider systems 14a-14m, travel agency systems 16a-16n, reservation databases 18a-18o, and booking folder database 20 may communicate through a network 24. The network 24 may include one or more private or public data networks (e.g., the Internet) that enable the exchange of data between systems connected to the network 24.

The GDS 12 may be configured to facilitate communication between the provider systems 14a-14m and travel agency systems 16a-16n by enabling travel agents, validating carriers, or other indirect sellers to book reservations on the provider systems 14a-14m via the GDS 12. To this end, the GDS 12 may maintain links to the provider systems 14a-14m via the network 24. These links may allow the GDS 12 to, for example, route reservation requests from the provider system of a validating carrier or travel agency system to the corresponding provider system for the operating carrier. The provider and travel agency systems may thereby book flights on multiple carriers via a single connection to the GDS 12. The GDS 12 may be based on highly-available service oriented architecture that is fully distributed. This fully distributed architecture may split the functions provided by the GDS 12 into several applications, with each application being responsible for providing a given set of services.

Each of the provider systems 14a-14m may include a Computer Reservation System (CRS) that enables the GDS 12 or travel agency systems 16a-16n to reserve and pay for travel products, such as airline tickets, hotel rooms, or rental vehicles. Each provider system may also interact with other provider systems 14a-14m, either directly or through the GDS 12, to enable, for example, a validating carrier to sell tickets for seats provided by the operating carrier. The operating carrier may then bill the validating carrier for the products provided. In some embodiments of the invention, one or more of the provider systems 14a-14m may include an Electronic Ticketing System (ETS) and/or a Departure Control System (DCS) for a corresponding carrier.

The travel agency systems 16a-16n may provide travel agents with an interface for accessing the GDS 12 that enables agents to search for and book travel products. One or more of the travel agency systems 16a-16n may also include a server application accessible by a traveler system (not shown) that enables the traveler to search for and book travel itineraries without the help of a travel agent. This application may comprise, for example, a travel-related website that is accessible over the network 24 using a client application such as a web-browser running on the traveler system.

In response to the traveler booking a product, the GDS 12 or a corresponding provider system 14a-14m may store a Passenger Name Record (PNR), or other type of reservation record, in one of the reservation databases 18a-18o, the aggregation database 22 and/or a logical partition of the aggregation database 22. The PNR may be generated, at least in part, by the corresponding the provider system, and may comprise one or more records that contain itinerary and traveler information. Each of the records in the PNR may define one or more reservations booked by the traveler. The PNR may also track usage of the purchased travel products, such as whether a booked flight has been flown. The PNR may be identified by a record locator unique to that PNR within its respective database, and may include records defining an itinerary for a particular trip, service, passenger, or group of passengers.

An action performed through the GDS 12 or one of the provider systems 14a-14m to change an itinerary (e.g., by adding a passenger, changing a flight, etc.) may cause the content or the state of the corresponding PNR to be modified. At least some of the elements contained in each PNR, such as remarks or special service requests, may be required to conform to a standard format defined by a standards body, e.g., the International Air Transport Association (IATA). This standardization may ensure data compatibility between different systems operating within the travel industry. However, the necessity to conform PNR elements to industry standards may also limit the features that can be supported using PNRs.

The booking folder database 20 may store booking folder records that provide a single database record for aggregating and managing a travel itinerary that is spread across multiple PNRs. Booking folder records may also be configured to store data that is incompatible with existing PNR standards, thereby enabling the deployment of new services. To this end, each booking folder record may comprise one or more elements that stores data needed for different use cases. For example, one element may store the record locator of each PNR linked to the booking folder record. Although depicted in FIG. 1 as being stored in separate databases, in an embodiment of the invention, the reservation records (e.g., PNRs) and booking folder records may be organized as separate logical databases within an aggregation database 22. The aggregation database 22 may be hosted by the GDS 12 or any other suitable system, or provided as part of a cloud based service.

The booking folder record may store PNR contextual data, such as the identity of the ticketing office that created the PNR or the point of sale of one or more travel products defined in the PNR. The booking folder may also store data that is found in one or more of the associated PNRs, such as name and contact information for one or more stakeholders, e.g., the traveler, travel agency or agent who booked the trip, the entity organizing or paying for the trip (such as an employer), or any other entity with an interest or stake in the trip. The booking folder record may thereby enable the GDS 12, provider systems 14a-14m, and/or travel agency systems 16a-16n to obtain trip details from a single source that associates a plurality of independent PNRs comprising a travel itinerary.

The booking folder record thus represents a new type of database record that stores new types of record elements without impacting the existing structure of standard PNR elements. The unique structure of the booking folder records may enable the booking folder database 20 to support new services without impacting legacy services provided by the GDS 12 and/or provider systems 14a-14m. The booking folder database 20 may enable separate handling of PNRs and booking folder records. This may allow legacy applications and databases which are incompatible with booking folder records to continue to operate using only PNRs, while allowing other applications and databases to use the additional features provided by the booking folder database 20. By preserving the standard format of the existing reservation systems and database records, the booking folder database 20 may enable deployment of new features while ensuring that these new features do not disrupt the operation of current GDS, travel agency, and provider system applications.

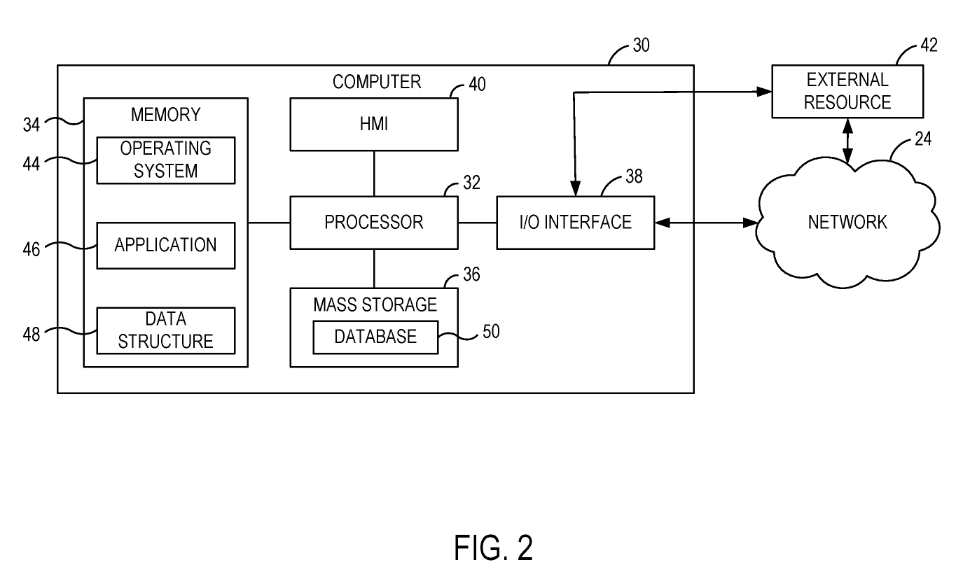

Referring now to FIG. 2, the GDS 12, provider systems 14a-14m, travel agency systems 16a-16n, reservation databases 18a-18o, booking folder database 20, aggregation database 22, and network 24 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 24 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, or application 46 to store or manipulate data.

The I/O interface 38 may provide a machine interface that operatively couples the processor 32 to other devices and systems, such as the network 24 or external resource 42. The application 46 may thereby work cooperatively with the network 24 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, persons having ordinary skill in the art will understand that embodiments of the invention may include applications that are located externally to the computer 30, distributed among multiple computers or other external resources 42, or provided by computing resources (hardware and software) that are provided as a service over the network 24, such as a cloud computing service.

The HMI 40 may be operatively coupled to the processor 32 of computer 30 to enable a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query, where the query may be dynamically determined and executed by the operating system 44, other applications 46, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database.

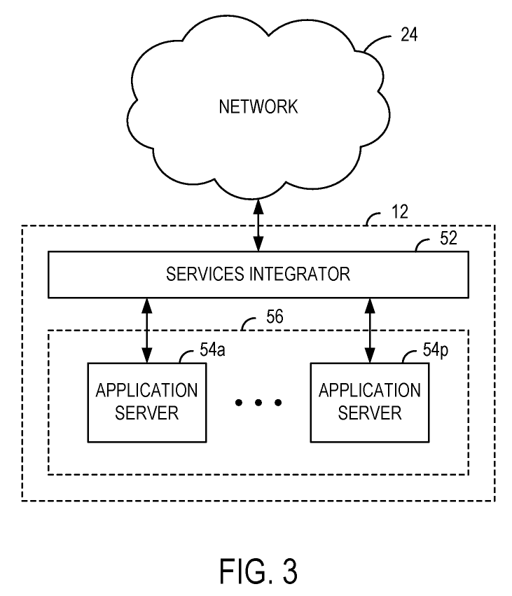

FIG. 3 depicts an embodiment of the GDS 12 having a distributed architecture that includes a services integrator 52 in communication with a plurality of application servers 54a-54p. The services integrator 52 may comprise a hardware and/or software module, such as a router or an enterprise service bus, configured to route messages between the network 24 and application servers 54a-54p, as well as between the application servers 54a-54p themselves. The application servers 54a-54p may comprise an Open Back End (OBE) layer 56 that hosts server applications which provide services to external and/or internal client applications. External systems that may be in communication with the GDS 12 over the network 24 may include the provider systems 14a-14m, the travel agency systems 16a-16n, or any other suitable external system, such as a user system that connects to a web server application over the Internet.

Exemplary GDS applications hosted by servers in the OBE layer 56 may include, but are not limited to, a reservation application, a Departure Control System (DCS) application, a ticketing application, a pricing application, an availability application, and/or a web server application. Each application running on the application servers 54a-54p may communicate with other applications through the services integrator 52 using any suitable communication protocol, such as the Electronic Data Interchange For Administration, Commerce and Transport (EDIFACT) and/or Extensible Markup Language (XML).

Messages generated by applications in the OBE layer 56 may be published externally using standard web services protocols, such as the Simple Object Access Protocol (SOAP). The interface for messages transmitted to and from external client applications may use publically available XML schemas. Internal messaging between applications in the OBE layer 56 may use an open protocol or a proprietary protocol, and may be context based. Context based communication may involve attaching a context of the record being processed by the application (e.g., a context of a PNR or a booking folder record) to each message that is transmitted from one server application to another server application. The context may include, for example, information that allows an application to retrieve a current copy of the record in question, or synchronization information that enables the destination server to determine if a local copy of the record is valid.

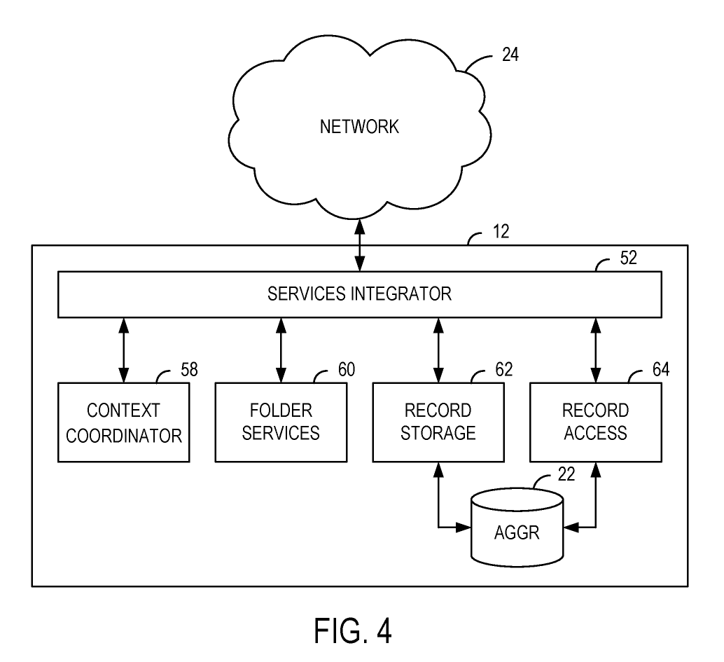

Referring now to FIG. 4, and in accordance with an embodiment of the invention, the GDS 12 may include a context coordinator application 58, a folder services application 60, a record storage application 62, a record access application 64, and the aggregation database 22. The context coordinator application 58, folder services application 60, record storage application 62, and record access application 64 may be viewed as collectively forming a database management application that creates, modifies, stores, and retrieves booking folder records and/or reservation records from the aggregation database 22. The applications and the database may be, for example, provided or managed by one or more servers in the OBE layer 56.

The context coordinator application 58 may be configured to maintain the context of a record during a user session with the GDS 12 during which the record may be modified or otherwise used to process data. To this end, the context coordinator application 58 may attach the context to incoming queries, and forward the query to the relevant application. In cases where the external applications involved in the user session employ booking folder records, the context coordinator application 58 may retrieve a booking folder record associated with the transaction from the aggregation database 22 and attach the booking folder record to the message being transmitted by storing the booking folder in a context header. Storing the booking folder in the context header may comprise attaching the booking folder record to the message using an Internet Protocol (IP) standard, such as the Multipurpose Internet Mail Extension (MIME) standard. In cases where a booking folder record is not being used (e.g., one or more of the applications involved are not compatible with booking folder records), the context coordinator application 58 may attach the context of the reservation record being processed to the message.

The folder services application 60 may be configured to create booking folder records and make any requested modifications to the booking folder record during the user session. The record storage application 62 may be configured to generate a folder identifier that uniquely identifies the booking folder record, and store the booking folder record in the aggregation database 22. The record access application 64 may be configured to retrieve booking folder records from the aggregation database 22 in response to queries from the other applications, such as the context coordinator application 58. The record storage and access applications may collectively manage storage and retrieval of booking folder records in the aggregation database 22. The record storage and access applications may also be configured to handle creation, storage, and access to reservation records in the aggregation database 22.

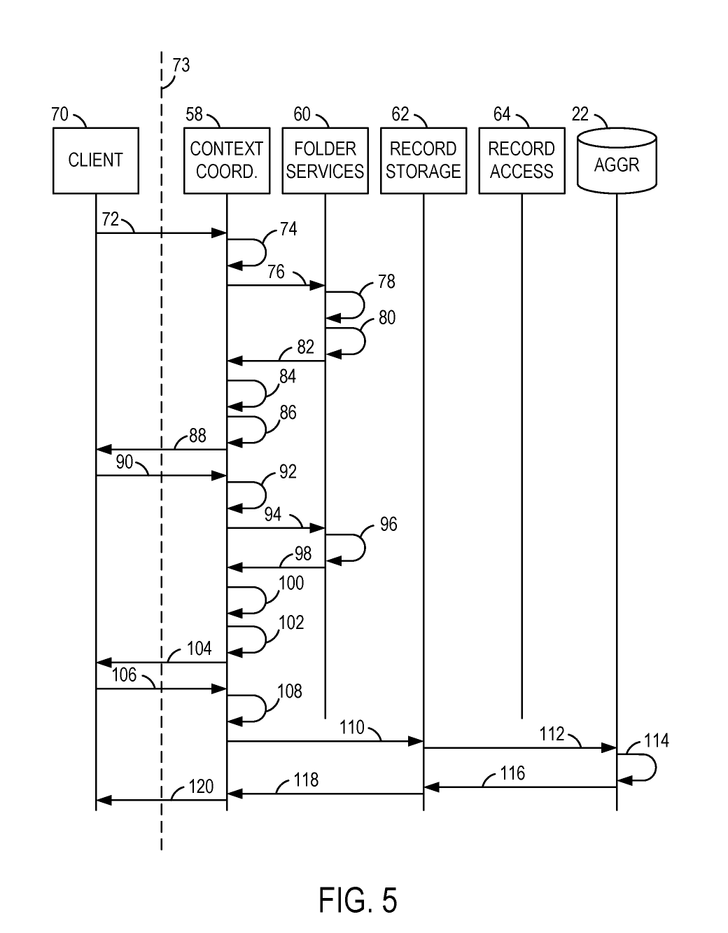

FIG. 5 depicts a sequence diagram that illustrates exemplary messaging between applications of a data processing system for creating a booking folder record. To initiate the process of creating a booking folder record, a client application 70, such as a reservation application running on one of the travel agency systems 16a-16n, may transmit 72 a query to the GDS 12 requesting creation of the booking folder record. The query may be transmitted via an Application Programming Interface (API) 73 that defines a set of protocols for communication between the client application 70 and the context coordinator 58. The query may include data defining a label for the booking folder, e.g., “Trip for Mr. Smith to New York”, and may be transmitted in response to receiving input via a user interface of the client application 70. The query may be received by the services integrator 52 and routed to the context coordinator application 58. In response to receiving the query, the context coordinator application 58 may attach 74 a context header to the query, and transmit 76 the query to the folder services application 60.

The folder services application 60 may, in response to receiving the query from the context coordinator application 58, create 78 a booking folder record. The booking folder record may comprise a plurality of segments or fields, with each field comprising one or more elements. The elements may be formatted, for example, using JavaScript Object Notation (JSON), or any other suitable format. Each element may be identified by an element identifier, e.g., a three letter code, that identifies the type of element. An exemplary booking folder record for the present example may include three segments and appear as follows:

fld { key: “FolderID” str: “*” }
fld { key: “Label” str: “Trip for Mr. Smith to New York” }
fld { key: “BookingFiles” ctn { } }

As can be seen, the above exemplary booking folder record includes a “FolderID” field that may initially be empty, a “Label” field that contains a string which defines the label for the booking folder record, and “BookingFiles” field, which may also initially be empty.

The folder services application 60 may store 80 the booking folder record in the context header, and transmit 82 a reply including the context header to the context coordinator application 58. In response to receiving the reply from the folder services application 60, the context coordinator application 58 may store 84 the booking folder record in a working memory and detach 86 the context header from the reply. The context coordinator application 58 may then transmit 88 the reply to the client application 70, thereby informing the client application 70 that the booking folder record has been created.

The booking folder record may comprise an agent context that is maintained in parallel with an existing reservation record, e.g., a PNR. The context coordinator application 58 may handle both the booking folder record and the reservation record at the same time without impacting the activities of other users, who can perform their usual work on the reservation record. Both the booking folder record and the reservation record may have separate lifetimes and can be manipulated independently. The folder services application 60 may receive a reservation record present in a user context, but typically does not modify the reservation record.

In response to receiving the reply from the GDS 12, the client application 70 may transmit 90 a query to the GDS 12 requesting that the GDS 12 associate one or more PNRs with the booking folder record. The query may be received by the services integrator 52 and routed to the context coordinator application 58. At 92, in response to receiving the query, the context coordinator application 58 may retrieve the booking folder record from the working memory, attach the context header to the query, and store the booking folder record in the context header. The context coordinator application 58 may then transmit 94 the query to the folder services application 60. In response to receiving the query, the folder services application 60 may modify 96 the booking folder record in accordance with the query.

The modification may include, for example, adding one or more fields to the booking folder record that includes record identifiers or locators identifying the one or more PNRs. For example, the folder services application 60 may add a field for each PNR identified in the query. Each of these added fields may contain the record locator of a respective one of the PNRs. Once the booking folder record has been modified, the folder services application 60 may transmit 98 a reply including the context header containing the booking folder record to the context coordinator application 58. For a query requesting that three PNRs be added to the booking folder record, the exemplary modified booking folder record may appear as follows:

| | |
|---|---|
| fld { | key: “FolderID” str: “*” } |
| fld { | key: “Label” str: “Trip for Mr. Smith to New York” } |
| fld { | key: “BookingFiles” ctn { |
| | fld { key: “UID” str: “ABCDE1” } |
| | fld { key: “UID” str: “ABCDE2” } |
| | fld { key: “UID” str: “ABCDE3” } } } |

As can be seen, three fields, or subfields, have been added to the booking folder record in the “BookingFiles” field. The PNRs are identified by exemplary record identifiers or locators “ABCDE1”, “ABCDE2”, and “ABCDE3” contained in these fields.

Other types of modifications are possible. For example, in response to a query, one or more of the PNRs identified in the query may be removed from the booking folder record by removing the respective record locator from a field in the booking folder record. This modification disassociates the PNR from the booking folder record.

Upon receiving the reply from the folder services application 60, the context coordinator application 58 may store 100 the modified booking folder record in the working memory, and detach 102 the context header from the reply. The context coordinator application 58 may then transmit 104 the reply to the client application 70.

Once the booking folder record has been created and populated with PNRs, the client application 70 may transmit 106 a commit command to the GDS 12. The command may be received by the services integrator 52 and routed to the context coordinator application 58. At 108, in response to receiving the commit command, the context coordinator application 58 may retrieve the booking folder record from the working memory, attach the context header to the command, and store the booking folder record in the context header. The context coordinator application 58 may then transmit 110 the command to the record storage application 62. The record storage application 62 may in turn transmit 112 a query to the aggregation database 22 requesting the database index and store the booking folder record. At 114, in response to receiving the query, the aggregation database 22 may assign a folder identifier to the booking folder record and store the booking folder record in the database. The exemplary stored booking folder record may appear as follows:

```
fld { key: “FolderID” str: “1234567890” }
fld { key: “Label” str: “Trip for Mr. Smith to New York” }
fld { key: “BookingFiles” ctn {
    fld { key: “UID” str: “ABCDE1” }
    fld { key: “UID” str: “ABCDE2” }
    fld { key: “UID” str: “ABCDE3” } } }
```

As can be seen, the booking folder record now includes the folder identifier “1234567890” stored in the “FolderID” field of the booking folder record.

Once the booking folder record has been indexed and stored, the aggregation database 22 may transmit 116 a confirmation to the record storage application 62 confirming that the booking folder record has been committed. The confirmation may include the folder identifier in the body of the message and an empty context header. In response to receiving the confirmation, the context coordinator application 58 may detach the header, and transmit 120 a reply to the client application 70 confirming the booking folder has been committed.

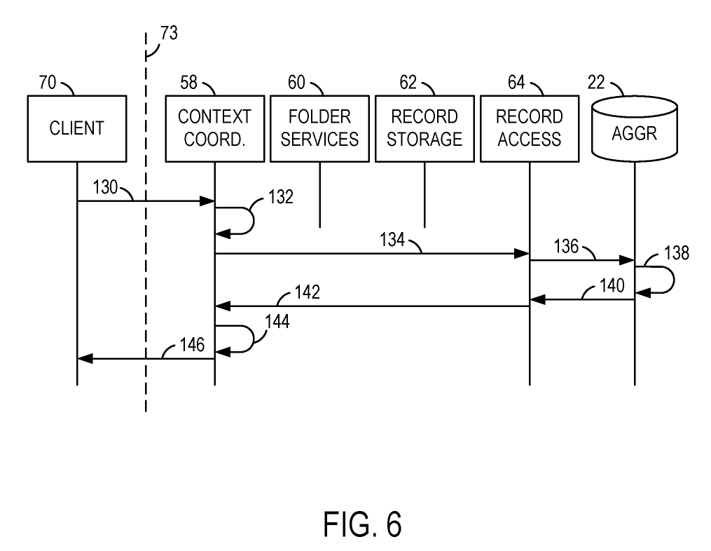

FIG. 6 depicts a sequence diagram that illustrates exemplary messaging that may be associated with retrieval of the booking folder record from the aggregation database 22. The client application 70 may, for example, retrieve the booking folder record from the aggregation database 22 to display or modify a travel itinerary defined therein. To this end, the client application 70 may transmit 130 a query to the GDS 12 via the API 73 requesting the booking folder record. The query may be transmitted, for example, in response to the client application 70 receiving a request to view a booking folder via the user interface of the client application 70. The query may include the folder identifier of the booking folder record to be retrieved, and may be received by the services integrator 52 and routed to the context coordinator application 58. In response to receiving the query, the context coordinator application 58 may attach 132 a context header to the query, and transmit 134 the query to the record access application 64.

In response to receiving the query, the record access application 64 may transmit 136 a query including the folder identifier to the aggregation database 22. The query may request the aggregation database 22 retrieve the booking folder record indexed to the folder identifier, which may be included in the body of the query. The aggregation database 22 may retrieve 138 the booking folder record identified by the folder identifier, and transmit 140 a reply to the record access application 64 that includes the booking folder record. The record access application 64 may, in response to receiving the reply, store the booking folder record in the context header and transmit 142 the reply including the header to the context coordinator application 58.

At 144, in response to receiving the reply, the context coordinator application 58 may store the booking folder record in the working memory and detach the context header from the reply. The context coordinator application 58 may then transmit 146 a reply to the client application that includes the booking folder record in the body of the message.

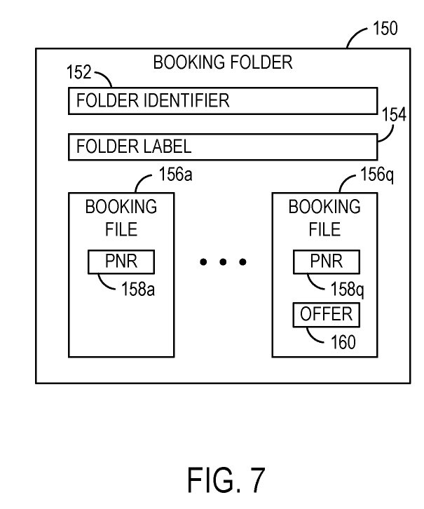

FIG. 7 depicts an exemplary aggregated view, or booking folder 150, that may be displayed to a system user by a user interface, such as the user interface of client application 70. The aggregation database 22 may enable applications used by travel and carrier agents for managing travel, such as applications running on a reservation system, Departure Control System (DCS), and/or mid and back office systems, to display booking folders. The booking folder 150 may include a folder identifier data field 152, a label data field 154, and one or more booking file data fields 156a-156q. The folder identifier data field 152 and label data field 154 may display the folder identifier and label defined in the booking folder record being accessed. Each booking file data field 156a-156q may correspond to a PNR 158a-158q or other reservation record that is identified by the booking folder record. Each booking file data field 156a-156q may display the contents of the respective PNR 158a-158q, and may also display additional elements, such as an offer 160 comprising a non-finalized booking stored in the associated reservation record 158q.

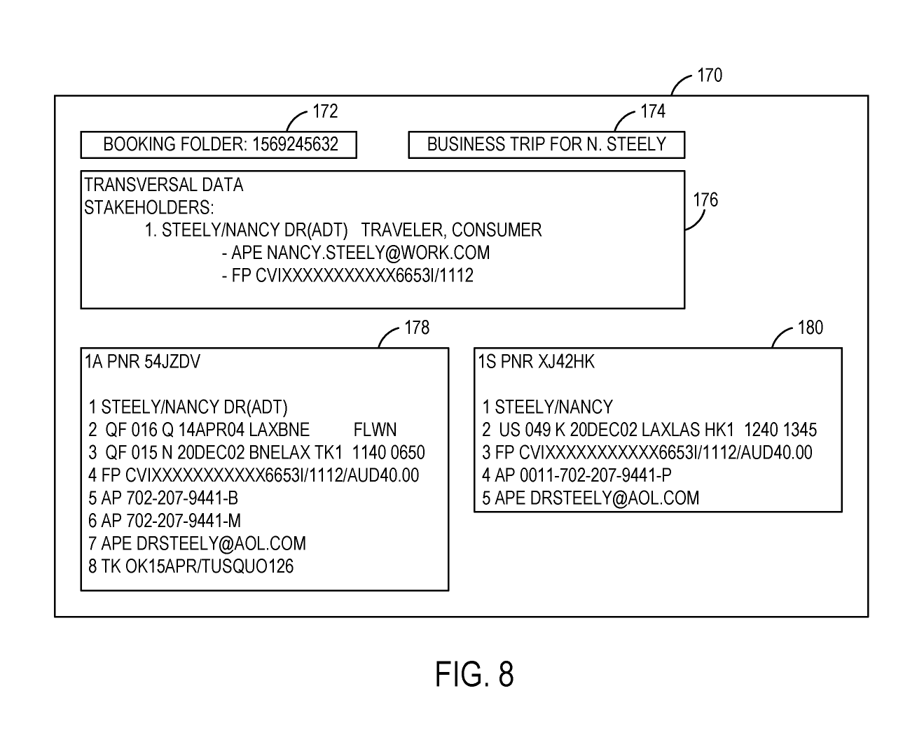

FIG. 8 depicts an exemplary booking folder 170 that aggregates different trip parts for a traveler into a consolidated itinerary. Booking folder 170 may be displayed in response to requesting retrieval of a booking folder record that is associated with PNRs for flights booked for a single traveler through different GDSs. The booking folder 170 may include a folder identifier data field 172, a label data field 174, a transversal data field 176, and a plurality of booking file data fields 178, 180. The folder identifier data field 172 may provide a folder identifier, e.g. “1569245632”, and the label data field 174 may display a descriptive label for the trip that is stored in the booking folder record, e.g., “Business trip for N. Steely”. The descriptive label may indicate, for example, a functional purpose of the booking folder.

The transversal data field 176 may display data stored in the booking folder record that is common to the trip. This data may include, for example, the identities and/or contact information for the stakeholders, e.g., traveler name “Nancy Steely”, one or more forms of payment (e.g., credit card, voucher, cash, etc.) used to purchase at least a portion of the travel products comprising the trip, a trip summary, one or more group counters, or any other suitable information or back-office data.

The booking file data fields 178, 180 of booking folder 170 may display contents of reservation records identified in the booking folder record, e.g., PNR 54JZDV from PNR database 1A (AMADEUS®), and PNR XJ42HK from PNR database 1S (SABRE®). The reservation records may be linked to each other by the common names found in name elements “1” of PNR 54JZDV and PNR XJ42HK, and/or by the common contact information in contact element “7” of PNR 54JZDV and contact element “5” of PNR XJ42HK. The reservation records may also be linked to the booking folder record by the common names found in the name elements of each of these records (“STEELY/NANCY”).

Groups of travelers may sometimes be split between multiple reservation records. However, decisions made by the travel provider may require consolidated figures about the whole group, e.g. total number of confirmed/ticketed passengers vs contracted allotment. The booking folder record may enable aggregation of all reservation records for the group. The booking folder record may thereby facilitate calculation of fares for the group, and provide a record in which to store decisions applicable for the group such as time limits. Time limits may include, for example, a ticket issuance time limit and/or an add name time limit. Booking folder records may also be used to aggregate non-homogeneous reservations for a group of travelers, thereby consolidating the full trip while allowing a dedicated itinerary (e.g., through a separate reservation record) for each traveler.

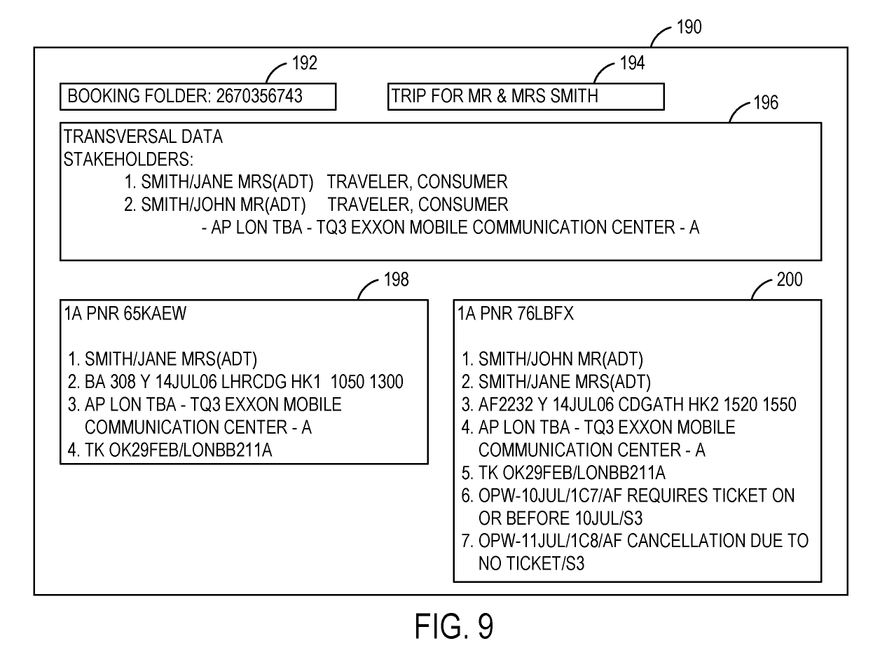

FIG. 9 illustrates an exemplary booking folder 190 that demonstrates some benefits the booking folder record may provide when used to manage groups of travelers. Booking folder 190 may be displayed by the client application 70 in response to requesting retrieval of a booking folder record that is associated with PNRs for flights booked for a group of travelers. In this exemplary travel scenario, John and Jane Smith may have recently been married, and plan to honeymoon in Greece. However, just before the planned departure, John Smith will be on a business trip in Paris while Jane Smith will be in London. To satisfy these requirements, PNR 65KAEW may have been created to reserve a flight for Jane Smith from Heathrow airport in London to Charles De Gaulle airport in Paris, where Jane Smith plans to join John Smith. Another PNR 76LBFX may have been created to reserve a flight for both Jane and John Smith departing from Charles De Gaulle in Paris and arriving in Athens.

The booking folder 190 may include an folder identifier data field 192, a label data field 194, a transversal data field 196, and a plurality of booking file data fields 198, 200. The transversal data field 176 may display data stored in the booking folder record, such as the identities and/or contact information for the stakeholders, e.g., traveler names “Jane Smith” and “John Smith”, and the conference which John Smith is attending in Paris. The fact that this trip is associated with a particular event (e.g., the conference) may, for example, allow Jane and John Smith to obtain discount fares on the flight from London to Paris and/or the flight from Paris to Athens that would otherwise not have been available. The booking file data fields 198, 200 of booking folder 190 may display contents of the reservation records (e.g., PNR 65KAEW and PNR 76LBFX) identified in the booking folder record.

Booking folders may provide a travel agent or other user with a complete aggregate view of the trip that would otherwise be unavailable. This view may improve management of disruptions in one part of the trip by indicating the need to adjust other parts of the trip. For example, under the above described scenario, the travel agent (or an application that monitors disruptions) may be notified of a delay or cancelation of Jane Smith's flight from London. Upon pulling up the booking folder 190, the travel agent (or the disruption monitoring application) may determine that the flight to Athens needs to be rebooked for a later time due to the delay in Jane Smith's flight from London. Without the aggregated view provided by the booking folder 190, it is unlikely that the travel agent would have been aware of need to rebook the flight to Athens since that flight was booked using a reservation record separate from the reservation record for the flight from London.

In addition to enabling applications to display aggregated views for the travel agent, the booking folder record may enable front, mid, and back office systems to obtain aggregated trip data from a single data container. The booking folder record may thereby enable services that provide trip management functionalities and enable future new business for travel agents and travel providers.

For example, one business application for the booking folder record may include managing revenue integrity by identifying duplicate bookings. Duplicate bookings may occur when space is booked that is not planned to be used. A duplicate booking may be determined by identifying space on at least one of multiple bookings that a passenger will not be able to use due to a conflict between the bookings. Duplicate bookings may occur, for example, if the passenger has two reservations on the exact same flight, the passenger has two overlapping reservations, or the passenger has two reservations for the same route with not enough time between the reservations to make the return flight. In order for the carrier to identify duplicate bookings, the carrier may need to identify bookings based on the passenger rather than on contracts with the travel agencies. This requirement may be due to the possibility that the passenger has duplicate bookings spread across multiple reservation records and/or with multiple travel agencies.

In some cases, a carrier detecting a duplicate booking may allow time for the travel agents involved to resolve the duplicate booking with the passenger prior to the carrier taking action. To this end, the carrier may set a time limit on the identified duplicate bookings, after which the carrier may take corrective actions if the travel agents have not resolved the duplicate booking. By linking passengers with reservation records across multiple reservation systems, the booking folder record may enable carriers to quickly identify and link duplicate passenger name records, and set timers for checking to see if the duplicate reservation records have been modified to resolve the problem.

By providing a single database record that is associated with each reservation record associated with a particular traveler, the booking folder record may enable carriers to re-evaluate these associated reservation records in near real time. The booking folder record may link multiple reservation records that apply to the same passenger, even if those reservation records are stored on different databases. Carriers may calculate inconsistencies across those reservation records, and apply fare rules such as time limits or minimum stay requirements across the entire trip. If discrepancies are found, the offending reservation records can be queued for correction or canceled.

The booking folder record may also facilitate managing revenue integrity across groups of travelers. Carriers may have special policies for large groups, but applying these policies may be difficult when the travel arrangements for the group have been split across multiple reservation records. Revenue integrity rules may require that certain conditions be fulfilled when booking a group of travelers. For example, the group may be required to provide a minimum deposit before a specified date, and to provide passenger names, passport information, and other mandatory data in specified increments that meet required thresholds before certain dates. The carrier may also be required to collect payment and issue tickets for the passengers in specified increments that meet required thresholds before certain dates. These conditions may apply to the whole group without regard to splits across multiple reservation records. The booking folder record may facilitate policing these types of group rules by linking together all reservation records that were booked as a group. The consolidated view provided by the booking folder may enable agents to check and enforce carrier policies for the group, store possible time limits for travel arrangers, and trigger actions by the carrier agents if the conditions of the group booking are not met.

In some cases, carrier pricing and other policies may be based on the origin and destination of travel rather than independently on each part of the itinerary. That is, carriers may wish to set policies that take into consideration a complete itinerary of a passenger rather than just individual segments connecting the origin to the destination. For example, polices regarding pending payments for part of a trip may apply different rules when the passenger has already started their trip, or if the trip is longer than a predetermined duration. When trips include travel products reserved in multiple reservation records, enforcement of these types of policies using systems lacking the booking folder feature may not be possible. The booking folder may enable applying policy rules that enforce revenue integrity on the complete itinerary of a traveler and which provide improved treatment of passengers with complex itineraries.

As another example, the booking folder record may facilitate providing services to a traveler or group of travelers that have travel booked across multiple reservation records. Typically, providing a service to a traveler with a travel itinerary spread across multiple reservation records requires the service to be separately booked in each reservation record. In conventional systems, this may require a travel agent to somehow identify each travel reservation. Providing the service may also require an agent for the carrier override default rules in order to apply specific fares or discounts, such as group discounts or reduced fares due to a return flight on another reservation record. In addition to increasing the workload and opportunity for mistakes by the agents, the resulting inability to automatically provide services across multiple reservation records may, for example, prevent carriers from offering services directly from their websites or through online travel agencies due to a lack of automation.

An example of a service that may be booked across multiple reservation records may include booking of cabin baggage. Booking cabin baggage may be a chargeable service that has a higher total price if booked for several individual flights as compared to booking the service for a single connecting flight. Another example may be for a family spread across multiple reservation records that wishes to sit together on the common flights in their itinerary. By linking together all the reservation records comprising a trip, the booking folder may enable travel providers to automatically link together the reservation records of a passenger or group of passengers, and perform joint service requests over all the linked reservation records.

As yet another example of a feature that may be enabled by the booking folder record, carriers and travel agencies may use booking folder records to maintain a personal travel record for high value travelers. This personal travel record may enable authorized parties to access past and current information for trips made by the high value traveler. The personal travel record may be provided by assigning permanent identifiers to the high value traveler and to a booking folder record associated with the traveler. This booking folder record may be used to provide a repository for all the trips taken by the traveler, thereby enabling travel agents and carriers to view all past and current trips booked by the high value traveler. Providing real time views of other trips taken by the high value traveler may allow travel agents to provide improved service to these travelers.

For at least the exemplary reasons described above, the booking folder record may provide gains in productivity by reducing the amount of time required to add a service to multiple reservation records and enter manual overrides of the fares and discounts. The booking folder record may also enable carriers to increase the value of products by offering services, fares, and discounts directly through travel agents or automated websites, leading to better customer satisfaction and increased upsell and cross-sell. The booking folder record may also enable a single payment for services on multiple reservation records, thereby simplifying the booking process and potentially reducing credit card fees for multiple transactions.

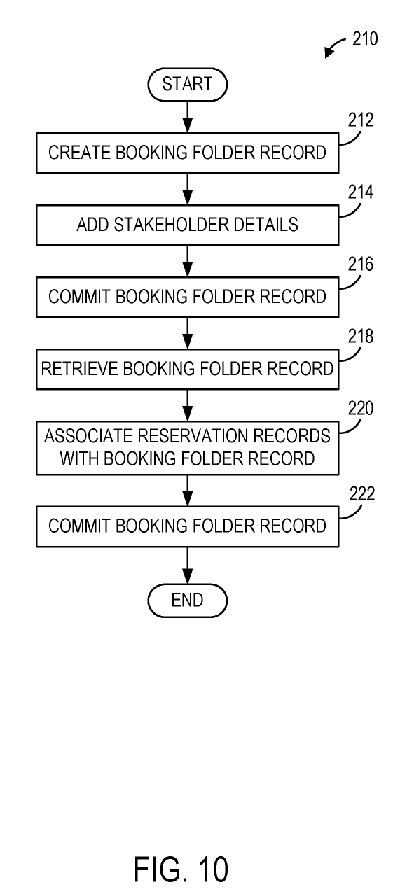

FIG. 10 depicts an exemplary process 210 that may be executed by one or more of the GDS 12 and client application 70 to create a booking folder. In an exemplary scenario, a travel agent may be asked to help with planning a trip. In response, the travel agent may provide input to the client application 70 indicating a desire to create a booking folder. To initiate creation of the booking folder, the client application 70 may transmit a query to the GDS 12 requesting the GDS 12 create a booking folder record. In block 212, and in response to receiving the request from the client application 70, the GDS 12 may create a booking folder record and store the booking folder record in a working memory location as described above with respect to FIG. 5.

In response to receiving a reply from the GDS 12 confirming creation of the booking folder record, the client application 70 may prompt the travel agent to enter information about the trip stakeholders. This data may include, for example, the names of any travelers and their contact information. In response to the travel agent entering this data, the client application 70 may transmit another query to the GDS 12 requesting the entered data be stored in the booking folder record. In block 214, and in response to receiving the query, the GDS 12 may add one or more fields to the reservation record, and store the stakeholder data in the added fields.

When the travel agent has finished entering the stakeholder data, the travel agent may provide input to the client application 70 indicating they wish to commit the booking folder. In response, the client application 70 may transmit a commit command to the GDS 12. In block 216, and in response to receiving the commit command, the GDS 12 may commit the booking folder record by generating a booking folder record identifier, and saving the booking folder record in the booking folder database 20. Committing the booking folder record by saving it in the booking folder database 20 may make the booking folder record visible to other applications.

The unique record identifier may be assigned to the booking folder when the booking folder record is first committed. In an embodiment of the invention, the unique record identifier may be a multi-digit (e.g., 10 digit) number. In contrast to some conventional reservation records, such as PNRs, this numeric format may enable the booking folder record to be accessed globally, including in areas where the Roman alphabet is not used, e.g., Asia, Russia, Middle East.

After the booking folder record has been committed, the travel agent may begin searching for travel products that satisfy the trip requirements of the traveler. As appropriate travel products are identified, the travel agent may create one or more reservation records (e.g., PNRs) that hold reservations for the identified travel products. The reservation records may be stored in a single reservation system or in multiple reservation systems. During the process of booking travel products for the trip, the travel agent may provide input to the client application 70 indicating that one or more reservation records should be added to the booking folder. In response, the client application 70 may send a query to the GDS 12 that identifies the reservation records to be added, e.g., by transmitting a query that includes the record locators of the reservation records and the identities of the corresponding databases in which the reservation records are stored.

In response to receiving this query, the GDS 12 may proceed to block 218, and retrieve the booking folder record from the booking folder database 20. The GDS 12 may then proceed to block 220 and associate the reservation records with the booking folder record. The reservation records may be associated with the booking folder record by, for example, adding one or more fields to the booking folder record, and storing the record locators in the added fields. In this way, reservation records may be associated with the booking folder record without any impact on the reservation records. Once the travel agent has finished adding reservation records to the booking folder, the travel agent may provide input to the client application indicating a desire to save the booking folder. In response to receiving this input, the client application 70 may transmit a commit command to the GDS 12. The GDS 12 may then proceed to block 222 and commit the booking folder record by saving the updated booking folder record in the booking folder database 20. Once saved, the changes to the booking folder record may be visible to other applications accessing the booking folder database 20.

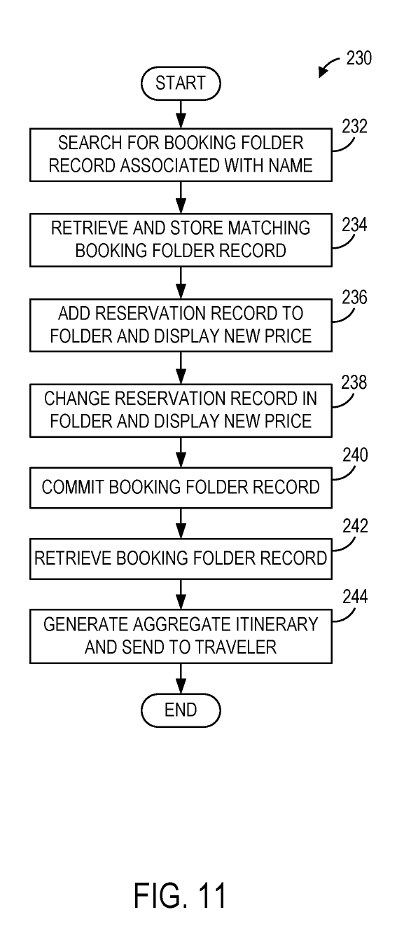

FIG. 11 depicts an exemplary process 230 that may be executed by one or more of the GDS 12 and client application 70 to add a travel product to an existing trip using the booking folder feature. After period of time (e.g., several days), the traveler in the above exemplary scenario may contact the travel agent and ask for an additional travel product to be added to the trip, such as a vehicle rental. The client application 70 may allow the travel agent to search for a booking folder based on the folder identifier, a record locator of one of the reservation records associated with the booking folder, the name of a traveler or other stakeholder, or any other element stored in, or associated with, the booking folder record. Thus, if the traveler does not know the folder identifier, the travel agent may search for the booking folder based on the name of the traveler.

To this end, the travel agent may enter the traveler's name in a search field of the client application 70, and the client application 70 may send a query to the GDS 12 requesting the GDS 12 return booking folder records that include the search term. In response to receiving the search query, the GDS 12 may proceed to block 232 and search the booking folder database 20 for booking folder records matching the traveler's name. In response to finding a matching booking folder record, the GDS 12 may proceed to block 234, retrieve the matching booking folder record from the booking folder database 20, store the record in a working memory location, and transmit the record to the client application 70. In cases where more than one matching booking folder record is found, the GDS 12 may transmit a response to the client application 70 that prompts the travel agent to select the correct booking folder record, or request a new search if none of the records appear correct.

In response to receiving the booking folder record, the client application 70 may retrieve reservation records associated with the booking folder record from their respective databases, and display the booking folder to the travel agent. The travel agent may then provide input to the client application 70 identifying a reservation record for the vehicle rental to be added to the trip. In response, the client application 70 may proceed to block 236, retrieve the reservation record from its respective database, add the reservation record to the booking folder, and display a new total price for the trip that includes the newly added reservation. The retrieval and addition of the reservation records to the booking folder record may be performed without any impact the reservation records themselves.

If the traveler is unwilling to commit to the new price, the travel agent may search for a lower cost vehicle rental, such as by reserving a lower priced category of vehicle. Once a substitute vehicle has been reserved, the travel agent may provide input to the client application 70 indicating that the new reservation record should be substituted for the previous reservation record. In response to receiving this input, the client application may proceed to block 238, remove the old reservation record from the booking folder, add the new reservation record to the booking folder, and display a new total price for the trip.

If the traveler agrees to pay the new total price, the travel agent may provide input to the client application 70 that causes the client application 70 to transmit a commit command to the GDS 12. In response to receiving the commit command, the GDS 12 may proceed to block 240, add the record locator for the new reservation record to the booking folder record, and commit the booking folder record by storing the booking folder record in the booking folder database 20. Once the booking folder record has been committed, the travel agent may send an itinerary summary to the traveler for the full trip. To generate this summary, the client application 70 may send a query to the GDS 12 to retrieve the booking folder record. In response to receiving the query, the GDS 12 may proceed to block 242, retrieve the booking folder record from the booking folder database 20, and transmit the booking folder record to the client application 70.

In response to receiving the booking folder record, the client application 70 may retrieve reservation records associated with the booking folder record from their respective databases, and display the booking folder to the travel agent. The client application 70 may then, at the prompting of the travel agent, proceed to block 244. In block 244, the client application 70 may generate an aggregate itinerary based on the contents of the booking folder, and transmit the aggregate itinerary to the traveler, e.g., using an email address or other traveler contact information in the booking folder.

At a later time, typically prior to departure, a mid-office application (not shown) may generate an invoice for the trip, and send the invoice to the traveler. To this end, the mid-office application may send a query to the GDS 12 requesting the booking folder record matching the folder identifier for the trip. In response to receiving the search query, the GDS 12 may retrieve the booking folder record identified by the folder identifier from the booking folder database 20, store the record in a working memory location, and transmit the record to the mid-office application. The mid-office application, in turn, may retrieve the reservation records identified by the booking folder record from their respective databases, generate an invoice based thereon, and transmit the invoice to the traveler.

The booking folder record enables the aggregation (i.e., grouping) of multiple reservation records without replicating data across copies of reservation records held at different systems. The booking folder record is stored in a centralized database so that an external system can access and retrieve the booking folder for viewing or modification based on a folder identifier. The reservation records associated with the booking folder record are specified based on the record identifiers in the retrieved booking folder and are retrieved from their corresponding databases to populate the booking folder with details of the reservation records and to permit modifications. The links to the reservation records through a single centralized source, i.e., the booking folder, may eliminate the need to replicate and store multiple copies of reservation records among different databases at the GDS 12 and the provider systems 14a-14m. In a conventional system with distributed copies containing replicated data, the travel data held in the different databases may become unsynchronized when a copy of a reservation record is modified in the database of one system without also modifying a copy of the reservation record held in a database at another system. The centralization afforded by the booking folder may eliminate the need to perform a synchronization operation that updates and corrects the copies of the data in the reservation records across the different system platforms operated by the GDS 12 and the provider systems 14a-14m.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A data processing system comprising:
one or more processors; and
a memory coupled to the one or more processors, the memory storing data comprising a booking folder database and program code, the program code being configured to, when executed by at least one of the one or more processors, cause the system to:
receive a first request to view a booking folder, the first request including a search term;
in response to receiving the first request, retrieve a booking folder record that matches the search term from the booking folder database, the booking folder record defining a first identifier that identifies a first reservation record;
use the first identifier from the booking folder record to retrieve the first reservation record; and
transmit the booking folder to a user system, the booking folder including first data from the first reservation record.

2. The data processing system of claim 1 wherein the program code is configured to cause the system to:
create the booking folder record in the booking folder database; and
associate the booking folder record with a reservation record.

3. The data processing system of claim 1 wherein the booking folder record further defines a second identifier that identifies a second reservation record, and the program code is further configured to cause the system to:
use the second identifier from the booking folder record to retrieve the second reservation record; and
add second data from the second reservation record to the booking folder.

4. The data processing system of claim 1 wherein the program code causes the system to retrieve the booking folder record by:
attaching, by a context coordinator, a context header to a query;
transmitting the query from the context coordinator to the booking folder database;
retrieving the booking folder from the booking folder database;
storing the booking folder in the context header;
attaching the context header to a reply;
transmitting the reply from the booking folder database to the context coordinator; and
detaching, by the context coordinator, the context header from the reply.

5. The data processing system of claim 1 wherein the program code is configured to cause the system to create the booking folder record in the booking folder database by:
receiving, prior to the first request, a second request that includes the search term and the first identifier;
in response to receiving the second request:
storing the search term in a first field of the booking folder record,
storing the first identifier in a second field of the booking folder record,
generating a folder identifier, and
storing the folder identifier in a third field of the booking folder record; and
storing the booking folder record in the booking folder database.

6. The data processing system of claim 1 wherein the booking folder is transmitted to the user system via an application programming interface, and further comprising:
a client computer running a client application that interfaces with the application programming interface and provides a user interface for displaying the booking folder; and
a server computer running a database management application that manages the booking folder database.

7. The data processing system of claim 1 wherein the booking folder record aggregates a plurality of reservation records without replicating data found in any of the reservation records.

8. The data processing system of claim 1 wherein the program code is further configured to cause the system to:
in response to receiving a second request to update an itinerary, retrieve the booking folder record;
use the first identifier from the booking folder record to retrieve the first reservation record; and
update the itinerary by modifying the first reservation record.

9. The data processing system of claim 1 wherein the program code is further configured to cause the system to:
in response to receiving a second request to update an itinerary, retrieve the booking folder record; and
update the itinerary by storing a second identifier in the booking folder record, the second identifier identifying a second reservation record that defines a travel product that is being added to the itinerary.

10. A method comprising:
receiving, at a data processing system, a first request to view a booking folder, the first request including a search term;
in response to receiving the first request, retrieving, by the data processing system from a booking folder database, a booking folder record that matches the search term, the booking folder record defining a first identifier that identifies a first reservation record;
using, by the data processing system, the first identifier from the booking folder record to retrieve the first reservation record; and
transmitting the booking folder to a user system, the booking folder including first data from the first reservation record.

11. The method of claim 10 further comprising:
creating the booking folder record in the booking folder database; and
associating the booking folder record with a reservation record.

12. The method of claim 10 wherein the booking folder record further defines a second identifier that identifies a second reservation record, and further comprising:
using the second identifier from the booking folder record to retrieve the second reservation record; and
adding second data from the second reservation record to the booking folder.

13. The method of claim 10 wherein retrieving the booking folder comprises:
attaching, by a context coordinator, a context header to a query;
transmitting the query from the context coordinator to the booking folder database;
retrieving the booking folder from the booking folder database;
storing the booking folder in the context header;
attaching the context header to a reply;
transmitting the reply from the booking folder database to the context coordinator; and
detaching, by the context coordinator, the context header from the reply.

14. The method of claim 10 further comprising creating the booking folder record in the booking folder database by:
receiving, prior to the first request, a second request that includes the search term and the first identifier;
in response to receiving the second request:
storing the search term in a first field of the booking folder record,
storing the first identifier in a second field of the booking folder record,
generating a folder identifier, and
storing the folder identifier in a third field of the booking folder record; and
storing the booking folder record in the booking folder database.

15. The method of claim 14 further comprising:
storing transversal data in a fourth field of the booking folder record.

16. The method of claim 10 wherein the booking folder is transmitted to the user system over an application programming interface, and the data processing system comprises a client application that interfaces with the application interface and provides a user interface for displaying the booking folder and a database management application that manages the booking folder database.

17. The method of claim 10 wherein the booking folder record aggregates a plurality of reservation records without replicating data found in any of the reservation records.

18. The method of claim 10 further comprising:
in response to receiving a second request to update an itinerary, retrieving the booking folder record;
using the first identifier from the booking folder record to retrieve the first reservation record; and
updating the itinerary by modifying the first reservation record.

19. The method of claim 10 further comprising:
in response to receiving a second request to update an itinerary, retrieving the booking folder record; and
updating the itinerary by storing a second identifier in the booking folder record, the second identifier identifying a second reservation record that defines a travel product that is being added to the itinerary.

20. A computer program product comprising:
a non-transitory computer-readable storage medium; and
program code stored on the non-transitory computer-readable storage medium that, when executed by one or more processors, causes the one or more processors to:
receive a first request to view a booking folder, the first request including a search term;
in response to receiving the first request, retrieve a booking folder record that matches the search term from a booking folder database, the booking folder record defining a first identifier that identifies a first reservation record;
use the first identifier from the booking folder record to retrieve the first reservation record; and
transmit the booking folder to a user system, the booking folder including first data from the first reservation record.
